(19) United States
(12) Patent Application Publication
(10) Pub. No.: US 2025/0279039 A1
(43) Pub. Date: Sep. 4, 2025

(54) GATE DRIVING CIRCUIT AND DISPLAY APPARATUS INCLUDING THE SAME

(71) Applicant: LG Display Co., Ltd., Seoul (KR)

(72) Inventors: Sujin HWANG, Paju-si (KR); Miyoung SON, Paju-si (KR); Hongjae SHIN, Paju-si (KR)

(73) Assignee: LG Display Co., Ltd., Seoul (KR)

(21) Appl. No.: 18/976,054

(22) Filed: Dec. 10, 2024

(30) Foreign Application Priority Data
Feb. 29, 2024 (KR) 10-2024-0029692

(51) Int. Cl. G09G 3/32; G09G 3/20

(52) U.S. Cl. CPC G09G 3/32; G09G 3/2092; G09G 2300/0408; G09G 2300/0842; G09G 2310/0267; G09G 2310/08

(57) ABSTRACT

The present disclosure relates to a micro LED display apparatus, and to a display apparatus capable of stably driving a gate driver within a gate in active (GIA) circuit. According to the present disclosure, it is possible to stably drive a gate driver within the GIA circuit of a display apparatus.

### CROSS REFERENCE TO RELATED APPLICATION

The present application claims priority to Korean Patent Application No. 10-2024-0029692, filed Feb. 29, 2024, the entire contents of which are incorporated herein for all purposes by this reference.

### BACKGROUND

### Field

The present disclosure relates to a display apparatus, and more specifically, to a gate driving circuit and a micro LED display apparatus including the same.

### Description of the Related Art

Recently, as society advances to the information-oriented society, the field of display apparatuses which visually express an electrical information signal is rapidly advancing. Various display apparatuses, having excellent performance in terms of thinness, lightness, and low power consumption, are being developed correspondingly.

Specific examples of display apparatuses include liquid crystal display apparatus (LCD), organic light emitting display Apparatus (OLED), quantum dot display apparatus, micro light emitting display apparatus (LED) (μLED), etc.

Such a display apparatus uses a timing controller, a data driver, a gate driver circuit, and a display panel for its operation.

### SUMMARY

As a display apparatus becomes thinner, a technology for embedding a gate driving circuit in a display panel is being developed. The gate driving circuit built into such a display panel is known as a gate in panel (GIP) circuit and a gate in active (GIA) circuit.

The GIA circuit of a micro LED (u LED) display apparatus is built into the display panel along with the pixel array. An object to be achieved by the present disclosure is to stably drive at least one gate driver within the GIA circuit.

The objects of the present disclosure are not limited to the above-described objects, and other objects not mentioned can be clearly understood by those skilled in the art from the following description.

To achieve these objects and other advantages of the present disclosure, as embodied and broadly described herein, a micro LED display apparatus according to an embodiment may comprise a timing controller which outputs image data, a display panel on which a plurality of pixel arrays connected to a data line are disposed, and a data driver which generates a data voltage based on the image data and applies the data voltage to the data line, wherein the pixel array comprises a gate in active (GIA) circuit that provides a scan signal to a subpixel, wherein the GIA circuit may comprise a first transistor including a gate electrode connected to an N-th scan signal, a source electrode connected to a gate high voltage, and a drain electrode connected to a B node, and a second transistor including a gate electrode connected to the N-th scan signal, a source electrode connected to the gate high voltage, and a drain electrode connected to a F node.

The display panel may include a first GIA region, a second GIA region, and a third GIA region.

The GIA circuit may comprise a first gate driver which provides a first scan signal to the subpixel and a second gate driver which provides a second scan signal to the subpixel.

The first gate driver and second gate driver may further comprise a third transistor including a gate electrode connected to a QB node, a source electrode connected to the gate high voltage, and a drain electrode connected to the N-th scan signal, and a fourth transistor including a gate electrode connected to a Q node, a source electrode connected to the N-th scan signal, and a drain electrode connected to an N-th clock signal.

The first gate driver and second gate driver may further comprise a capacitor disposed between the N-th scan signal and the Q node.

A pulse width of the second scan signal may be shorter than a pulse width of the first scan signal, a pulse width for applying the data voltage may be longer than the pulse width of the first scan signal.

The GIA circuit may further comprise a fifth transistor including a gate electrode connected to a forward start signal, a source electrode connected to the Q node, and a drain electrode connected to a front-stage voltage, and a sixth transistor including a gate electrode connected to a reverse start signal, a source electrode connected to a rear-stage voltage, and a drain electrode connected to the Q node.

The channel lengths of the fifth transistor and sixth transistor may be longer than a length of the gate electrode.

In another aspect of the present disclosure, a gate driving circuit according to an embodiment may comprise a gate in active (GIA) circuit which provides a scan signal to a subpixel, wherein the GIA circuit may comprise a first transistor including a gate electrode connected to an N-th scan signal, a source electrode connected to a gate high voltage, and a drain electrode connected to a B node, and a second transistor including a gate electrode connected to the N-th scan signal, a source electrode connected to the gate high voltage, and a drain electrode connected to a F node.

The GIA circuit may be disposed on a first GIA region, second GIA region, and third GIA region of a display panel.

The GIA circuit may comprise a first gate driver which provides a first scan signal to the subpixel, and a second gate driver which provides a second scan signal to the subpixel.

The first gate driver and second gate driver may further comprise a third transistor including a gate electrode connected to a QB node, a source electrode connected to the gate high voltage, and a drain electrode connected to the N-th scan signal, and a fourth transistor including a gate electrode connected to a Q node, a source electrode connected to the N-th scan signal, and a drain electrode connected to an N-th clock signal.

The first gate driver and second gate driver may further comprise a capacitor disposed between the N-th scan signal and the Q node.

A pulse width of the second scan signal may be shorter than a pulse width of the first scan signal, a pulse width for applying the data voltage may be longer than the pulse width of the first scan signal.

The GIA circuit may further comprise a fifth transistor including a gate electrode connected to a forward start signal, a source electrode connected to the Q node, and a drain electrode connected to a front-stage voltage, and a sixth transistor including a gate electrode connected to a reverse start signal, a source electrode connected to a rear-stage voltage, and a drain electrode connected to the Q node.

The channel lengths of the fifth transistor and sixth transistor may be longer than a length of the gate electrode.

Additional features and aspects of the disclosure will be set forth in the description that follows and in part will become apparent from the description or may be learned by practice of the inventive concepts provided herein. Other features and aspects of the inventive concepts may be realized and attained by the structure particularly pointed out in, or derivable from, the written description, claims hereof, and the appended drawings.

It is to be understood that both the foregoing general description and the following detailed description of the present disclosure are by way of example and are intended to provide further explanation of the disclosures as claimed.

### BRIEF DESCRIPTION OF THE DRAWINGS

The accompanying drawings, which are included to provide a further understanding of the disclosure and are incorporated in and constitute a part of this application, illustrate example embodiments of the disclosure and together with the description serve to explain the principles of the disclosure.

FIG. 1 is a block diagram showing a display apparatus according to embodiments of the present disclosure.

FIG. 2 is a circuit diagram showing a subpixel of a display apparatus according to embodiments of the present disclosure.

FIG. 3 is a block diagram showing a display panel according to an embodiment of the present disclosure.

FIG. 4 is a block diagram showing a pixel array according to an embodiment of the present disclosure.

FIG. 5 is a block diagram showing a gate driver according to an embodiment of the present disclosure.

FIG. 6 is a circuit diagram showing a gate driver according to an embodiment of the present disclosure.

FIG. 7 is a timing diagram of a subpixel according to an embodiment of the present disclosure.

FIG. 8 is a timing diagram of a gate driver according to an embodiment of the present disclosure.

FIGS. 9 and 10 are circuit diagrams showing gate drivers according to another embodiment of the present disclosure.

FIG. 11 is a circuit diagram showing a gate driver according to another embodiment of the present disclosure.

FIGS. 12, 13, and 14 are circuit diagrams showing gate drivers according to other embodiments of the present disclosure.

### DETAILED DESCRIPTION

Advantages and features of the present disclosure and methods of achieving them will become apparent with reference to the example embodiments described below in detail in conjunction with the accompanying drawings. The present disclosure may, however, be embodied in different forms and should not be construed as limited to the example embodiments set forth herein. Rather, these example embodiments are provided so that this disclosure will be thorough and complete and will fully convey the scope of the present disclosure to those skilled in the art.

The shapes, dimensions, areas, lengths, thicknesses, ratios, angles, numbers, and the like, which are illustrated in the drawings to describe various example embodiments of the present disclosure, are merely given by way of example. Therefore, the present disclosure is not limited to such illustrated details in the drawings. Like reference numerals generally denote like elements throughout the specification, unless otherwise specified.

In the following description, where a detailed description of a relevant known function or configuration may unnecessarily obscure aspects of the present disclosure, a detailed description of such a known function or configuration may be omitted or be briefly discussed.

Where a term like “comprise,” “have,” “include,” or “done” is used, one or more other elements may be added unless the term is used with a more limiting term, such as “only” or the like. An element described in a singular form may include a plurality of elements, and vice versa, unless the context clearly indicates otherwise.

In construing an element, the element should be construed as including an error or tolerance range even where no explicit description of such an error or tolerance range is provided.

Where a positional relationship between two elements is described with such a term as “on,” “above,” “under,” “next to,” or the like, one or more other elements may be located between the two elements unless the term is used with a more limiting term, such as “immediate(ly)” or “direct(ly).”

Although terms “first,” “second,” and the like may be used herein to describe various elements, these elements should not be interpreted to be limited by these terms as they are not used to define a particular essence, order, sequence, precedence, or number of such elements. These terms are used only to refer one element separately from another. For example, a first element could be termed a second element, and a second element could similarly be termed a first element, without departing from the scope of the present disclosure.

Features of various embodiments of the present disclosure may be partially or wholly coupled to or combined with each other, and may be operated, linked, or driven together in various ways as those skilled in the art can sufficiently understand. The embodiments of the present disclosure may be carried out independently from each other, or may be carried out together in association with each other.

Hereinafter, various embodiments of the present disclosure will be described in detail with reference to the accompanying drawings. In the following embodiments, a display apparatus will be described for a micro LED (μLED), but the present disclosure is not limited thereto.

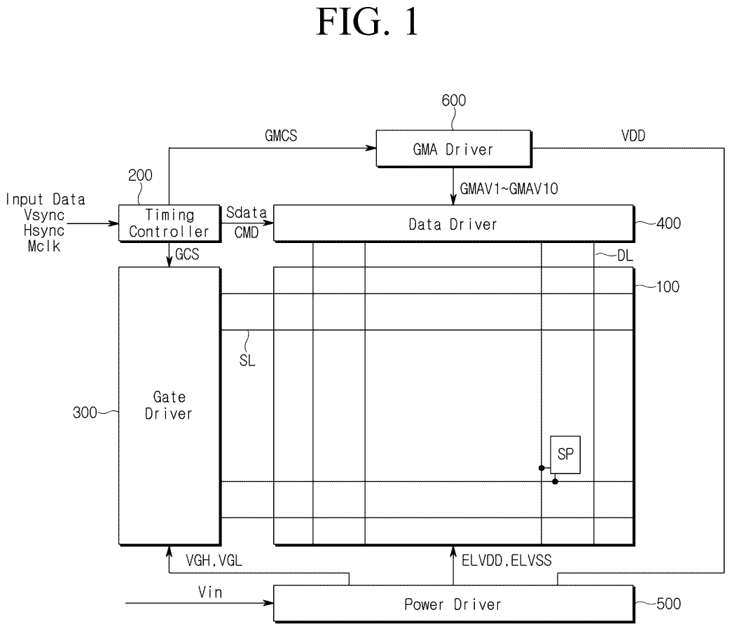

FIG. 1 is a block diagram showing a display apparatus according to embodiments of the present disclosure.

As shown in FIG. 1, a display apparatus according to embodiments of the present disclosure may include a display panel 100, a timing controller 200, a gate driver 300, a data driver 400, a power driver 500, and a gamma driver 600.

The display panel 100 includes a pixel array that displays an input image on a screen. The pixel array may include a plurality of data lines DL, a plurality of scan lines SL crossing the data lines DL, and subpixels SP arranged in a matrix form.

The display panel 100 may be implemented as a non-transmissive display panel or a transmissive display panel. The display panel 100 may be manufactured as a flexible display panel. The flexible display panel may be implemented as a micro LED (μLED) using a plastic substrate.

The timing controller 200 may receive digital image data Data of an input image and timing signals Vsync, Hsync, Clk synchronized therewith from a set system. The image data Data in digital form is a data signal of a differential signal and may be serial data. The timing signal may include a vertical synchronization signal Vsync, a horizontal synchronization signal Hsync, and a clock Clk. The set system may include a television, a monitor, a set-top box, a navigation system, a personal computer, a home theater system, a mobile device, a wearable device, a vehicle systems, etc.

The timing controller 200 may control the operation timing of the display panel 100 according to an input frequency. The input frequency may be 60 Hz in the National Television Standards Committee (NTSC) format. Recently, display apparatus that operate at a higher frequency of 120 Hz have become popular. Additionally, a display apparatus that operates at 120 Hz may be temporarily controlled to operate at 60 Hz in some cases. Additionally, recently, display apparatuses that support variable refresh rate (VRR), which operate by lowering the frame frequency to between 1 Hz and 30 Hz in a low-speed driving mode and increasing the frame frequency to 144 Hz in high-resolution video (e.g., gaming mode), are also being developed.

The timing controller 200 may output serial image data Sdata provided to the data driver 400, command data CMD for controlling the data driver 400, a gate control signal GCS for controlling the gate driver 300, and a gamma control signal GMCS for controlling the gamma driver 600, on the basis of the received timing signals Vsync, Hsync, Clk.

The gate driver 300 may be implemented as a gate driving circuit such as a Gate In Panel (GIP) circuit or a Gate In Active (GIA) circuit formed directly on the display panel 100 along with the TFT array and wiring of the pixel array. The gate driver 300 may sequentially output gate signals to the scan lines SL under the control of the timing controller 200. The gate driver 300 may sequentially output the signals to a plurality of scan lines SL by shifting the gate signal using a shift register.

The data driver 400 may use the gamma reference voltages GMAV1 to GMAV10 provided from a digital-to-analog converter (not shown) and the gamma driver 600 to convert the input image received as a digital signal from the timing controller 200 into a gamma compensation voltage in each frame period, and may output the data voltage VDATA. The data driver 400 may be implemented with multiple source drive integrated circuits. The data driver 400 may be electrically connected to the data lines DLs of the display panel 100 through a chip on glass (COG) process or tape automated bonding (TAB) process.

The power driver 500 may output direct current power required to drive the pixel array of the display panel 100 and the drivers 300, 400, and 600 using a DC-DC converter. The power driver 500 may receive a direct current input voltage Vin and generate direct current voltages such as gate high voltage VGH, gate low voltage VGL, high-potential emission voltage EVDD, low-potential emission voltage EVSS, and high-potential reference voltage VDD.

Specifically, the gate high voltage VGH is a voltage set above the threshold voltage of transistors formed in the subpixels SPs. The gate high voltage VGH is output to the gate driver 300 and may be supplied to a level shifter within the gate driver 300.

The gate low voltage VGL is a voltage lower than the threshold voltage of transistors formed in the subpixels SPs. The gate low voltage VGL may be supplied to the level shifter within the gate driver 300.

The high-potential emission voltage EVDD is a voltage supplied to the anode electrode of a light emitting device and is a positive voltage that drives the light emitting device. The high-potential emission voltage EVDD may be supplied to a high-potential power line connected to each subpixel SP within the display panel 100.

The low-potential emission voltage EVSS is a voltage supplied to the cathode electrode of a light emitting device and is a negative voltage that drives the light emitting device. The low-potential emission voltage EVSS may be supplied to a low-potential power line connected to each subpixel SP within the display panel 100.

The high-potential reference voltage VDD is a voltage output to the gamma driver 600. The high-potential reference voltage VDD may be used as a reference for generating the gamma reference voltages GMAV1 to GMAV10.

The gamma driver 600 may receive a high-potential reference voltage VDD output from the power driver 500. The gamma driver 600 may receive the gamma control signal GMCS from the timing controller 200, generate the gamma reference voltage GMAV1 to GMAV10 having a value between the high-potential reference voltage VDD and a ground voltage (0V), and the data driver 400 may output a data voltage based on the gamma reference voltages GMAV1 to GMAV10.

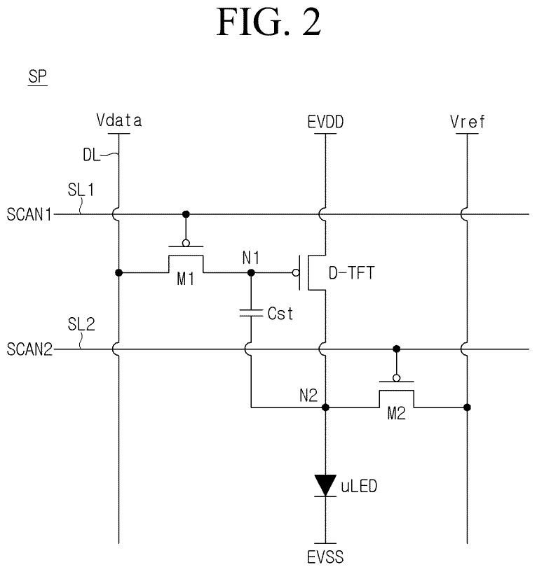

FIG. 2 is a circuit diagram showing a subpixel of a display apparatus according to embodiments of the present disclosure.

As shown in FIG. 2, the subpixel SP includes a micro LED μLED, a driving transistor D-TFT, a storage capacitor Cst, a first transistor M1, and a second transistor M2.

The micro LED μLED emits light depending on the driving current. The micro LED μLED may include an anode electrode and a cathode electrode, the drain electrode of a driving transistor D-TFT may be connected to the anode electrode, and the low-potential light emission voltage EVSS may be connected to the cathode electrode.

The driving transistor D-TFT is coupled between the micro LED μLED and the high-potential light emission voltage EVDD, and may control the driving current to emit the micro LED μLED according to the data voltage VDATA applied to the gate electrode. The driving transistor D-TFT may include a source electrode, a gate electrode, and a drain electrode. The gate electrode of the driving transistor D-TFT corresponds to a first node N1, and the drain electrode corresponds to the second node N2. The high-potential emission voltage EVDD may be connected to the source electrode of the driving transistor D-TFT.

The storage capacitor Cst may be connected between the gate electrode and drain electrode of the driving transistor D-TFT. The storage capacitor Cst may sample the data voltage VDATA and may boost the gate electrode of the driving transistor D-TFT when the first transistor M1 is turned on.

The first transistor M1 may be connected between the data line DL and the gate electrode of the driving transistor D-TFT. Additionally, the first transistor M1 may be connected between the data line DL and one electrode of the storage capacitor Cst.

The data voltage VDATA is applied to the data line DL, and the first transistor M1 may transmit the data voltage VDATA to the first node N1 in response to the first scan signal SCAN1 applied through the first scan line SL1.

The second transistor M2 is connected between the power line to which the reference voltage VREF is applied and the second node N2. The second transistor M2 may pre-charge the second node N2 with the reference voltage VREF in response to the second scan signal SCAN2 applied through the second scan line SL2.

Depending on the embodiment, the driving transistor D-TFT, the first transistor M1, and the second transistor M2 may be implemented as a low temperature polycrystalline oxide (LTPS) transistor or an oxide semiconductor transistor, but are not limited thereto. For example, the driving transistor D-TFT, the first transistor M1, and the second transistor M2 may be constituted with a P-type oxide thin film transistor or N-type oxide thin film transistor.

The subpixel SP according to an embodiment of the present disclosure is not limited thereto, and may include a transistor and a capacitor in addition to the micro LED μLED, the driving transistor D-TFT, and the storage capacitor Cst.

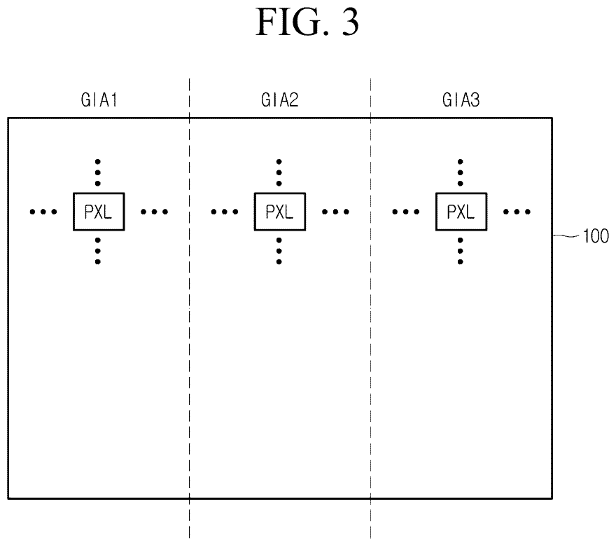

FIG. 3 is a block diagram showing a display panel according to an embodiment of the present disclosure.

As shown in FIG. 3, the display panel 100 may include a first GIA area GIA1, a second GIA area GIA2, and a third GIA area GIA3. A plurality of pixel arrays PXLs may be disposed in each of the first GIA area GIA1, the second GIA area GIA2, and the third GIA area GIA3.

As shown in FIGS. 2 and 3, the pixel array PXL includes the subpixel SP shown in FIG. 2, and may include a GIA circuit that provides a scan signal to the scan line SL of the subpixel SP.

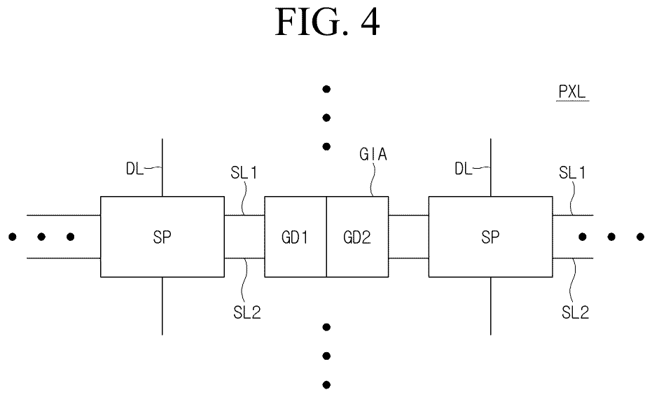

FIG. 4 is a block diagram showing a pixel array according to an embodiment of the present disclosure.

As shown in FIGS. 2 to 4, the plurality of pixel arrays PXLs may be disposed in each of the first GIA region GIA1, second GIA region GIA2, and third GIA region GIA3, and each of the plurality of pixels PXLs may include a subpixel SP and a GIA circuit.

For example, the GIA circuit may be disposed on the center line of each of the first region GIA1, second region GIA2, and third region GIA3, and a plurality of pixel circuits SPs may be disposed on both sides of the GIA circuit.

As shown in FIGS. 1 and 4, the subpixel SP may be connected to the data driver 400 through the data line DL. Additionally, the subpixel SP may be connected to the GIA circuit through the first scan line SL1 and second scan line SL2. Accordingly, the subpixel SP may receive the data voltage VDATA from the data driver 400 and the first scan signal SCAN1 and second scan signal SCAN2 from the GIA circuit.

As shown in FIG. 4, the GIA circuit may include two gate drivers GDs, that is, a first gate driver GD1 and a second gate driver GD2.

As shown in FIGS. 2 and 4, the first gate driver GD1 may generate a first scan signal SCAN1 and transmit the first scan signal SCAN1 to the first transistor M1 of the subpixel SP. The first transistor M1 may provide the data voltage VDATA to the subpixel SP in response to the first scan signal SCAN1. Additionally, the second gate driver GD2 may generate a second scan signal SCAN2 and provide the second scan signal SCAN2 to the second transistor M2 of the subpixel SP. The second transistor M2 may provide a reference voltage VREF to the second node N2 in response to the second scan signal SCAN2.

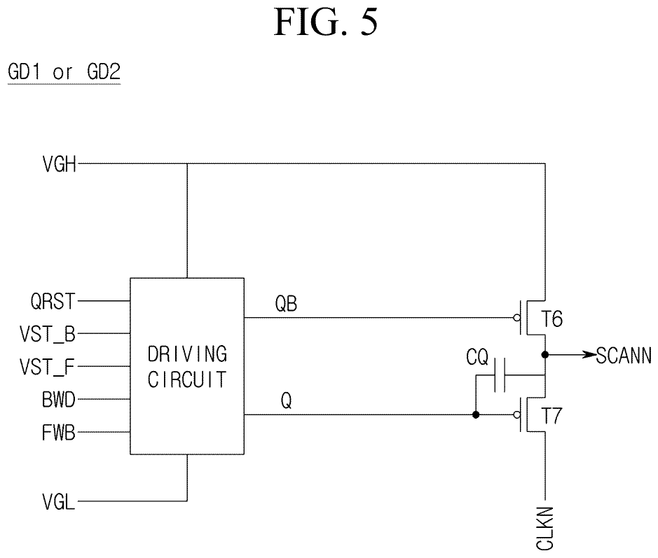

FIG. 5 is a block diagram showing a gate driver according to an embodiment of the present disclosure.

The gate driver may be the first gate driver GD1 that generates the first scan signal SCAN1 or the second gate driver GD2 that generates the second scan signal SCAN2.

As shown in FIG. 5, the gate driver GD may include a driving circuit, a transistor T6, and a transistor T7.

The driving circuit DRIVING CIRCUIT may charge or discharge the QB node or Q node using at least one of the gate high voltage VGH, gate low voltage VGL, front-stage voltage FWD, and rear-stage voltage BWD, in response to at least one of a global reset signal QRST, a forward start signal VST_F, and a reverse start signal VST_B.

The gate high voltage VGH may be connected to the source electrode of the transistor T6, and the N-th scan signal SCANN may be connected to the drain electrode. Additionally, a QB node may be connected to the gate electrode of the transistor T6. The transistor T6 may pull-up drive the N-th scan signal SCANN according to the signal of the QB node.

The N-th scan signal SCANN may be connected to the source electrode of the transistor T7, and the N-th clock signal CLKN may be connected to the drain electrode. Additionally, a Q node may be connected to the gate electrode of the transistor T7. The transistor T7 may pull-down drive the N-th scan signal SCANN according to the signal of the Q node.

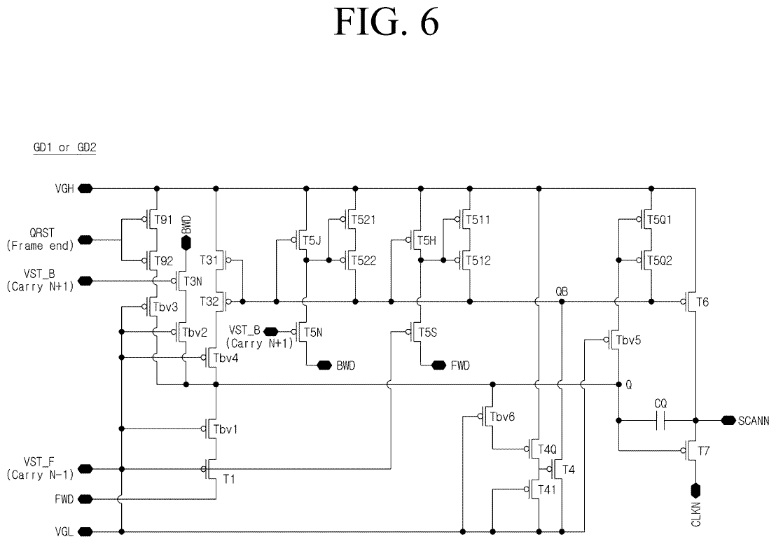

FIG. 6 is a circuit diagram showing a gate driver according to an embodiment of the present disclosure.

The gate driver may include a plurality of stage circuits, and each of the plurality of stage circuits may be configured as a circuit as shown in FIG. 6. The gate driver may be the first gate driver GD1 or the second gate driver GD2.

As shown in FIG. 6, the gate driver may include the transistor T6 and the transistor T7. In the transistor T6, the gate high voltage VGH is connected to the source electrode, the N-th scan signal SCANN is connected to the drain electrode, and the QB node is connected to the gate electrode. The transistor T6 may pull-up drive the N-th scan signal SCANN in response to the signal of the QB node. Here N may be 1 or 2.

In the transistor T7, the N-th scan signal SCANN is connected to the source electrode, the N-th clock signal CLKN is connected to the drain electrode, and the Q node is connected to the gate electrode. The transistor T7 may pull-down drive the N-th scan signal SCANN according to the N-th scan signal SCANN in response to the signal of the Q node. Here N may be 1 or 2.

The gate driver may further include a transistor T91, a transistor T92, and a transistor Tbv3. The transistors T91 and T92 may apply the gate high voltage VGH to the transistor Tbv3 according to the global reset signal QRST. The global reset signal QRST may be applied at each end of frame of an image to initialize the Q node to the gate high voltage VGH. The transistor Tbv3 may apply the gate high voltage VGH to the Q node according to the gate low voltage VGL.

In addition, the gate driver may further include a transistor T1 and a transistor Tbv1. When the gate driver is a first stage circuit among the plurality of stage circuits, the transistor T1 may transfer the front-stage voltage FWD to the transistor Tbv1 in response to the forward start signal VST_F. The transistor Tbv1 may apply the front-stage voltage FWD to the Q node according to the gate low voltage VGL. Here, the front-stage voltage FWD may be set to the same level as the gate low voltage VGL.

The transistor T1 and transistor Tbv1 may discharge the Q node to the front-stage voltage FWD during forward operation. In this case, the transistor T7 may pull-down drive the N-th scan signal SCANN according to the N-th clock signal CLKN by discharging the Q node. Here, the forward operation may be defined as driving sequentially from the first stage circuit to the last stage circuit among a plurality of stage circuits.

When the gate driver is a second stage circuit or a last stage circuit among a plurality of stage circuits, the transistor T1 may transfer the front-stage voltage FWD to the transistor Tbv1 according to the (N−1)-th carry signal Carry N−1. Here, the (N−1)-th carry signal Carry N−1 may be a signal output from the previous stage circuit in a forward direction.

In addition, the gate driver may further include a transistor T3N and a transistor Tbv2. When the gate driver is the first stage circuit among the plurality of stage circuits, the transistor T3N may transfer the rear-stage voltage BWD to the transistor Tbv2 according to the reverse start signal VST_B. The transistor Tbv2 may transfer the rear-stage voltage BWD to the Q node according to the gate low voltage VGL. Here, the rear-stage voltage BWD may be set to the same level as the gate high voltage VGH.

When operating in the reverse direction, the transistors T3N and Tbv2 may charge the Q node with the rear-stage voltage BWD. In this case, the transistor T7 may pull-up drive the N-th scan signal SCANN according to the N-th clock signal CLKN by charging the Q node. Here, the reverse operation may be defined as driving sequentially from the last stage circuit to the first stage circuit among a plurality of stage circuits.

When the gate driver is the second stage circuit or first stage circuit from the last among a plurality of stage circuits, the transistor T3N may transfer the rear-stage voltage BWD to the transistor Tbv2 according to the (N+1)-th carry signal Carry N+1. Here, the (N+1)-th carry signal Carry N+1 may be a signal output from the previous stage circuit in a reverse direction.

In addition, the gate driver may further include transistors T31 and T32 and a transistor Tbv4. The transistors T31 and T32 may apply the gate high voltage VGH to the transistor Tbv4 according to the signal of the QB node. The transistor Tbv4 may apply the gate high voltage VGH to the Q node according to the gate low voltage VGL.

The transistors T31 and T32 and the transistor Tbv4 may turn off the transistor T7 by transferring the gate high voltage VGH to the Q node while the transistor T6 is turned on due to the discharge of the QB node.

In addition, the gate driver may further include transistors T4 and T41, a transistor T4Q, and a transistor Tbv6. While the Q node is charged, the transistors T4 and T41 may turn on the transistor T6 by applying the gate low voltage VGL to the QB node according to the gate low voltage VGL.

While the transistor T7 is turned on due to the discharge of the Q node and applies the N-th clock signal CLKN to the N-th scan signal SCANN, the transistor T4Q and transistor Tbv6 may turn off the transistor T6 to prevent the QB node from discharging.

In addition, the gate driver may further include a transistor T5S, transistors T511, T512, and transistor T5H. The transistor T5S, transistors T511, T512, and transistor T5H may control the signal of the QB node during the forward operation.

During the forward operation, the transistor T5S may apply the front-stage voltage FWD to the transistors T511 and T512 according to the forward start signal VST_F or (N−1)-th carry signal Carry N−1.

The transistors T511, T512 may apply the gate high voltage VGH to the QB node according to the front-stage voltage FWD, and the transistor T5H may turn off the transistors T511, T512 according to the signal of the QB node.

In addition, the gate driver may further include a transistor T5N, transistors T521, T522, and transistor T5J. The transistor T5N, transistors T521, T522, and transistor T5J may control the signal of the QB node during the reverse operation.

During the reverse operation, the transistor T5N may apply the rear-stage voltage BWD to the transistors T521 and T522 according to the reverse start signal VST_B or (N+1)-th carry signal Carry N+1.

The transistors T521, T522 may apply the gate high voltage VGH to the QB node according to the rear-stage voltage BWD, and the transistor T5J may turn off the transistors T521, T522 according to the signal of the QB node.

In addition, the gate driver may further include transistors T5Q1 and T5Q2 and a transistor Tbv5. The transistor Tbv5 may transfer the signal of the Q node to the transistors T5Q1 and T5Q2 according to the gate low voltage VGL. The transistors T5Q1 and T5Q2 may apply the gate high voltage VGH to the QB node in response to the signal of the Q node.

While the transistor T7 is turned on and applies the N-th clock signal CLKN to the N-th scan signal SCANN due to the discharge of the Q node, the transistors T5Q1 and T5Q2 and the transistor Tbv5 may turn off the transistor T6 by applying the gate high voltage VGH to the QB node.

In addition, the gate driver may further include a stabilization capacitor CQ. The stabilization capacitor CQ is connected between the N-th scan signal SCANN and the Q node to stabilize the voltage level when the N-th scan signal SCANN is output.

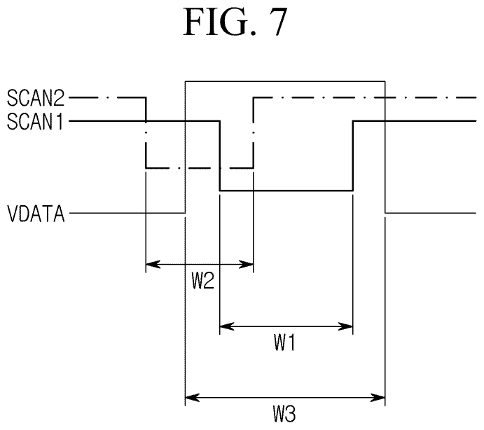

FIG. 7 is a timing diagram of a subpixel according to an embodiment of the present disclosure.

As shown in FIGS. 2 and 7, the subpixel SP first receives the second scan signal SCAN2 from the second gate driver GD2. In this case, the second transistor M2 of the subpixel SP may apply the reference voltage VREF to the second node N2 according to the second scan signal SCAN2. Next, the subpixel SP receives the data voltage VDATA from the data driver 400.

Thereafter, the subpixel SP receives the first scan signal SCAN1 from the first gate driver GD1. In this case, the first transistor M1 of the subpixel SP may apply the data voltage VDATA to the first node N1 according to the first scan signal SCAN1.

As a result, the storage capacitor Cst of the subpixel SP samples the data voltage VDATA, and the driving transistor D-TFT supplies a driving current corresponding to the voltage of the first node N1 to the micro LED μLED to make the micro LED μLED to emit light.

As shown in FIG. 7, the pulse width W2 of the second scan signal SCAN2 may be set shorter than the pulse width W1 of the first scan signal SCAN1, and the pulse width W3 for applying the data voltage VDATA may be set to be longer than the pulse width W1 of the first scan signal SCAN1. That is, the pulse widths of the first scan signal W1, second scan signal W2, and data voltage VDATA may be set to W2<W1<W3.

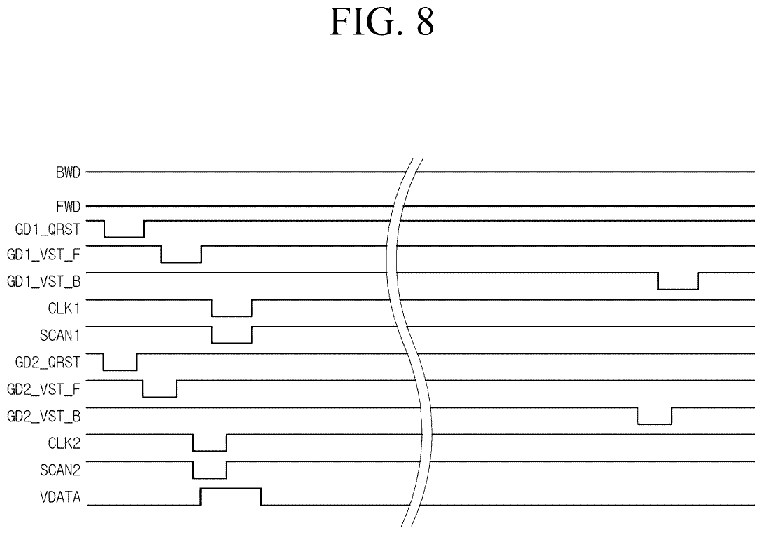

FIG. 8 is a timing diagram of a gate driver according to an embodiment of the present disclosure.

As shown in FIG. 8, during the forward operation, the front-stage voltage FWD may be set to the same level as the gate high voltage VGH, and the rear-stage voltage BWD may be set to the same level as the gate low voltage VGL.

The first gate driver GD1 may first initialize the QB node to the gate low voltage VGL and the Q node to the gate high voltage VGH according to a first global reset signal GD1_QRST.

Next, the first gate driver GD1 may start driving by charging the QB node with the front-stage voltage FWD and discharging the Q node to the rear-stage voltage BWD according to a first forward start signal GD1_VST_F. In this case, the first gate driver GD1 may output the first scan signal SCAN1 to the first scan line SL1 of the display panel 100 according to the first clock signal CLK1.

Lastly, the first gate driver GD1 may terminate the driving by discharging the QB node to the rear-stage voltage BWD and charging the Q node with the front-stage voltage FWD in response to a first reverse start signal GD1_VST_B.

The second gate driver GD2 may first initialize the QB node to the gate low voltage VGL and the Q node to the gate high voltage VGH according to a second global reset signal GD2_QRST.

Next, the second gate driver GD2 may start driving by charging the QB node with the front-stage voltage FWD and discharging the Q node to the rear-stage voltage BWD according to a second forward start signal GD2_VST_F. In this case, the second gate driver GD2 may output the second scan signal SCAN2 to the second scan line SL2 of the display panel 100 according to the second clock signal CLK2.

Lastly, the second gate driver GD2 may terminate the driving by discharging the QB node to the rear-stage voltage BWD and charging the Q node with the front-stage voltage FWD in response to a second reverse start signal GD2_VST_B.

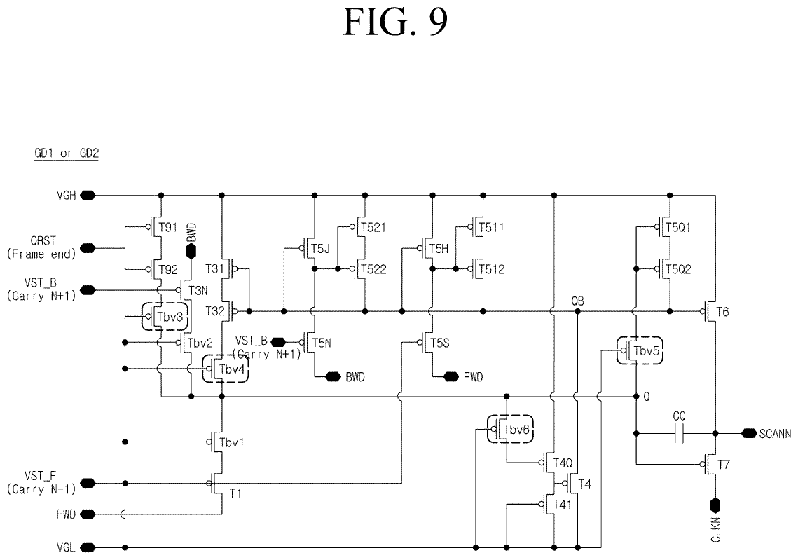

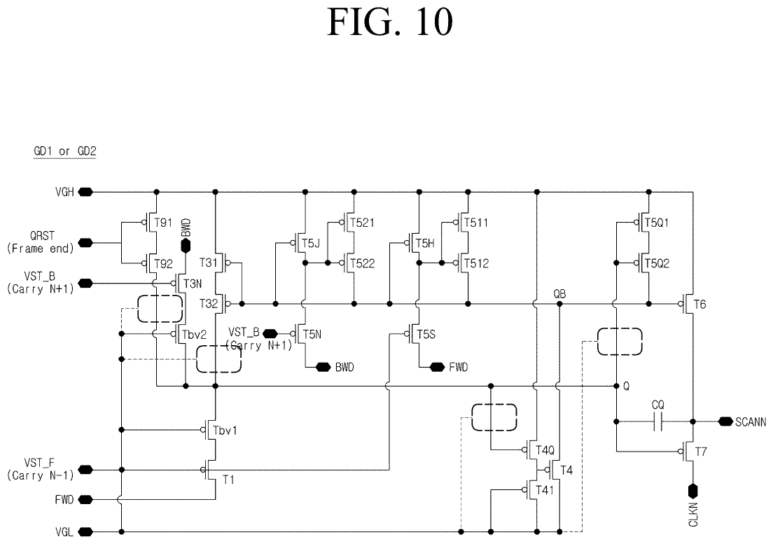

FIGS. 9 and 10 are circuit diagrams showing gate drivers according to another embodiment of the present disclosure.

As shown in FIG. 9, the gate electrodes of the transistors Tbv3, Tbv4, Tbv5, and Tbv6 may be connected to the gate low voltage VGL, and the source electrode or drain electrode may be connected to the Q node.

In the transistor Tbv3, the gate electrode may be connected to the gate low voltage VGL, the source electrode may be connected to the transistor T92, and the drain electrode may be connected to the Q node. The transistor Tbv3 may stabilize the Q node by applying the drain voltage of the transistor T92 to the Q node according to the gate low voltage VGL.

In the transistor Tbv4, the gate electrode may be connected to the gate low voltage VGL, the source electrode may be connected to the transistor T32, and the drain electrode may be connected to the Q node. The transistor Tbv4 may stabilize the Q node by applying the drain voltage of the transistor T32 to the Q node according to the gate low voltage VGL.

In the transistor Tbv5, the gate electrode may be connected to the gate low voltage VGL, the source electrode may be connected to the gate electrodes of the transistors T5Q1 and T5Q2, and the drain electrode may be connected to the Q node. The transistor Tbv5 may stabilize the QB node by applying the voltage of the Q node to the gate electrodes of the transistors T5Q1 and T5Q2 according to the gate low voltage VGL.

In the transistor Tbv6, the gate electrode may be connected to the gate high voltage VGH, the source electrode may be connected to the Q node, and the drain electrode may be connected to the gate electrode of the transistor T4Q. The transistor Tbv6 may stabilize the QB node by applying the voltage of the Q node to the gate electrode of the transistor T4Q according to the gate low voltage VGL.

If the gate electrodes of the transistors Tbv3, Tbv4, Tbv5, and Tbv6 are continuously connected to the gate low voltage VGL, bias stress may intensify, and the threshold voltages of the transistors may change. For example, when positive bias stress occurs, the threshold voltage of the transistor may increase and the current flowing through the transistor may decrease. In addition, when negative bias stress occurs, the threshold voltage of the transistor may decrease and the current flowing through the transistor may increase.

As shown in FIG. 10, the positive bias stress or negative bias stress may be prevented from occurring by deleting the transistors Tbv3, Tbv4, Tbv5, and Tbv6.

The drain electrode of the transistor T92 may be connected to the Q node, the drain electrode of the transistor T32 may be connected to the Q node, the gate electrode of the transistors T5Q1 and T5Q2 may be connected to the Q node, and the gate electrode of the transistor T4Q may be connected to the Q node.

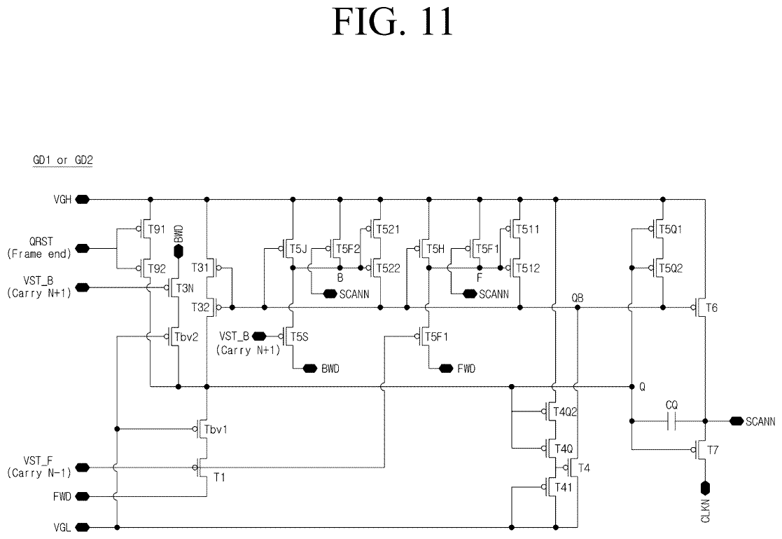

FIG. 11 is a circuit diagram showing a gate driver according to another embodiment of the present disclosure.

As shown in FIG. 11, the gate driver GD may further include transistors T5F1, T5F2, and T4Q2, and the channel lengths of the transistors T91 and T92 and transistors T31 and T32 may be increased.

The gate electrode of the transistor T5F1 may be connected to the N-th clock signal CLKN, the source electrode may be connected to the gate high voltage VGH, and the drain electrode may be connected to the F node.

The gate electrode of the transistor T5F2 may be connected to the N-th clock signal CLKN, the source electrode may be connected to the gate high voltage VGH, and the drain electrode may be connected to the B node.

The gate electrode of the transistor T4Q2 may be connected to the Q node, the source electrode may be connected to the gate high voltage VGH, and the drain electrode may be connected to the source electrode of the transistor T4Q.

In addition, the Q node may be stabilized even by increasing the channel length of the transistors T91 and T92 and transistors T31 and T32 and deleting the transistors Tbv3 and Tbv4.

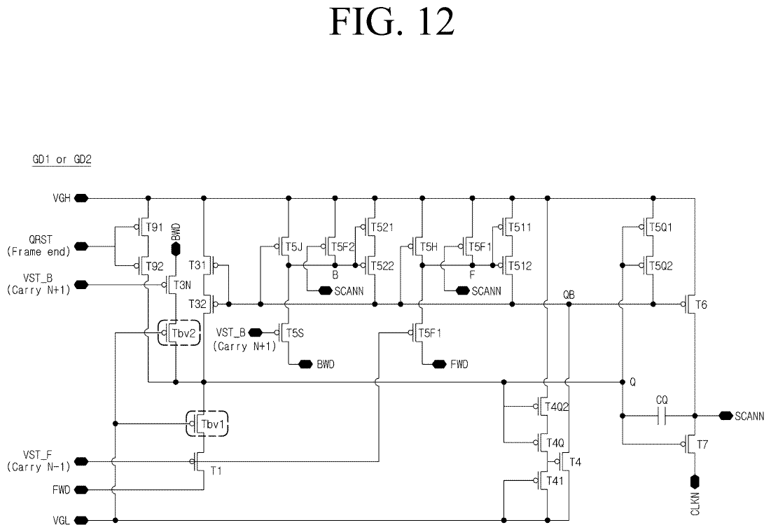

FIGS. 12, 13, and 14 are circuit diagrams showing gate drivers according to other embodiments of the present disclosure.

As shown in FIG. 12, the gate electrodes of the transistors Tbv1 and Tbv2 may be connected to the gate low voltage VGL, and the source electrode or drain electrode may be connected to the Q node.

The gate electrode of the transistor Tbv1 may be connected to the gate low voltage VGL, the source electrode may be connected to the Q node, and the drain electrode may be connected to the source electrode of the transistor T1. The transistor Tbv1 may stabilize the Q node by applying the source voltage of the transistor T1 to the Q node according to the gate low voltage VGL.

In the transistor Tbv2, the gate electrode may be connected to the gate low voltage VGL, the source electrode may be connected to the drain electrode of the transistor T3N, and the drain electrode may be connected to the Q node. The transistor Tbv4 may stabilize the Q node by applying the drain voltage of the transistor T3N to the Q node according to the gate low voltage VGL.

If the gate electrodes of the transistors Tbv1 and Tbv2 are continuously connected to the gate low voltage VGL, bias stress may intensify, and the threshold voltages of the transistors may change.

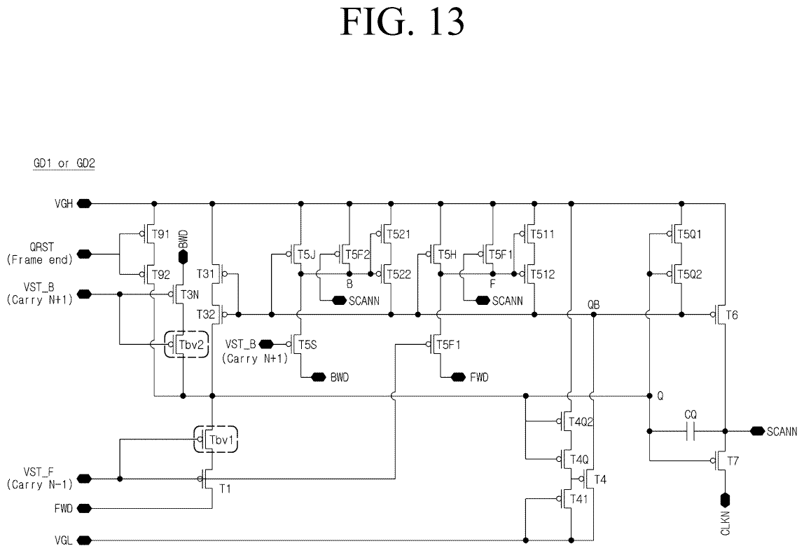

As shown in FIG. 13, the gate electrodes of the transistors Tbv1 and Tbv2 may be connected to the forward start signal VST_F and reverse start signal VST_B, respectively. That is, in the transistor Tbv1, the gate electrode may be connected to the forward start signal VST_F, the source electrode may be connected to the Q node, and the drain electrode may be connected to the source electrode of the transistor T1. In addition, in the transistor Tbv2, the gate electrode may be connected to the reverse start signal VST_B, the source electrode may be connected to the drain electrode of the transistor T3N, and the drain electrode may be connected to the Q node.

If the gate electrodes of the transistors Tbv1 and Tbv2 are connected to the forward start signal (VST_F) or reverse start signal (VST_B), the Q node may be stabilized by preventing the positive bias stress or negative bias stress from occurring.

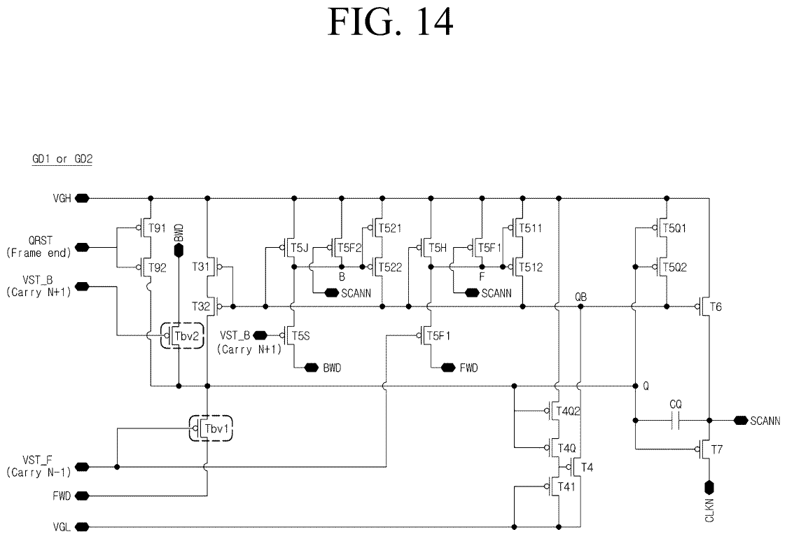

As shown in FIGS. 13 and 14, the transistor T1 may be deleted by increasing the channel length of the transistor Tbv1, and the transistor T3N may be deleted by increasing the channel length of the transistor Tbv2. In this case, the channel lengths of the transistors Tbv1 and Tbv2 may be longer than the length of the gate electrode.

That is, in the transistor Tbv1, the gate electrode may be connected to the forward start signal VST_F, the source electrode may be connected to the Q node, and the drain electrode may be connected to the front-stage voltage FWD. in addition, in the transistor Tbv2, the gate electrode may be connected to the reverse start signal VST_B, the source electrode may be connected to the rear-stage voltage BWD, and the drain electrode may be connected to the Q node.

The micro LED display apparatus according to embodiments can stably drive a gate driver within a GIA circuit.

It will be apparent to those skilled in the art that the present disclosure is not limited by the above-described example embodiments and the accompanying drawings, and that various substitutions, modifications, and variations can be made in the present disclosure without departing from the spirit or scope of the disclosures. Therefore, the above example embodiments of the present disclosure are provided for illustrative purposes and are not intended to limit the scope or technical concept of the present disclosure. The protective scope of the present disclosure should be construed based on the following claims and their equivalents, and it is intended that the present disclosure cover all modifications and variations of this disclosure that come within the scope of the claims and their equivalents.

What is claimed is:

1. A micro LED display apparatus, comprising:
a timing controller configured to output image data;
a display panel on which a pixel array connected to a data line is disposed; and
a data driver configured to generate a data voltage based on the image data and to apply the data voltage to the data line,
wherein the pixel array comprises a gate in active (GIA) circuit configured to provide a scan signal to a subpixel in the pixel array, and
wherein the GIA circuit comprises:
a first transistor including a gate electrode connected to an N-th scan signal, a source electrode connected to a gate high voltage, and a drain electrode connected to a B node; and
a second transistor including a gate electrode connected to the N-th scan signal, a source electrode connected to the gate high voltage, and a drain electrode connected to an F node.

2. The micro LED display apparatus of claim 1, wherein the display panel includes a first GIA region, a second GIA region, and a third GIA region.

3. The micro LED display apparatus of claim 1, wherein the GIA circuit further comprises:
a first gate driver configured to provide a first scan signal to the subpixel; and
a second gate driver configured to provide a second scan signal to the subpixel.

4. The micro LED display apparatus of claim 3, wherein the first gate driver and second gate driver comprise:
a third transistor including a gate electrode connected to a QB node, a source electrode connected to the gate high voltage, and a drain electrode connected to the N-th scan signal; and
a fourth transistor including a gate electrode connected to a Q node, a source electrode connected to the N-th scan signal, and a drain electrode connected to an N-th clock signal.

5. The micro LED display apparatus of claim 4, wherein the first gate driver and second gate driver further comprise a capacitor disposed between the N-th scan signal and the Q node.

6. The micro LED display apparatus of claim 3, wherein:
a pulse width of the second scan signal is shorter than a pulse width of the first scan signal; and
a pulse width for applying the data voltage is longer than the pulse width of the first scan signal.

7. The micro LED display apparatus of claim 1, wherein the GIA circuit further comprises:
a fifth transistor including a gate electrode connected to a forward start signal, a source electrode connected to the Q node, and a drain electrode connected to a front-stage voltage; and
a sixth transistor including a gate electrode connected to a reverse start signal, a source electrode connected to a rear-stage voltage, and a drain electrode connected to the Q node.

8. The micro LED display apparatus of claim 7, wherein channel lengths of the fifth transistor and sixth transistor are longer than a length of the gate electrode.

9. A gate driving circuit, comprising:
a gate in active (GIA) circuit configured to provide a scan signal to a subpixel,
wherein the GIA circuit comprises:
a first transistor including a gate electrode connected to an N-th scan signal, a source electrode connected to a gate high voltage, and a drain electrode connected to a B node; and
a second transistor including a gate electrode connected to the N-th scan signal, a source electrode connected to the gate high voltage, and a drain electrode connected to an F node.

10. The gate driving circuit of claim 9, wherein the GIA circuit is disposed on a first GIA region, a second GIA region, and a third GIA region of a display panel.

11. The gate driving circuit of claim 9, wherein the GIA circuit further comprises:
a first gate driver configured to provide a first scan signal to the subpixel; and
a second gate driver configured to provide a second scan signal to the subpixel.

12. The gate driving circuit of claim 11, wherein the first gate driver and second gate driver comprise:
a third transistor including a gate electrode connected to a QB node, a source electrode connected to the gate high voltage, and a drain electrode connected to the N-th scan signal; and
a fourth transistor including a gate electrode connected to a Q node, a source electrode connected to the N-th scan signal, and a drain electrode connected to an N-th clock signal.

13. The gate driving circuit of claim 12, wherein the first gate driver and second gate driver further comprise a capacitor disposed between the N-th scan signal and the Q node.

14. The gate driving circuit of claim 11, wherein:
a pulse width of the second scan signal is shorter than a pulse width of the first scan signal; and
a pulse width for applying a data voltage is longer than the pulse width of the first scan signal.

15. The gate driving circuit of claim 9, wherein the GIA circuit further comprises:
a fifth transistor including a gate electrode connected to a forward start signal, a source electrode connected to the Q node, and a drain electrode connected to a front-stage voltage; and
a sixth transistor including a gate electrode connected to a reverse start signal, a source electrode connected to a rear-stage voltage, and a drain electrode connected to the Q node.

16. The gate driving circuit of claim 15, wherein channel lengths of the fifth transistor and sixth transistor are longer than a length of the gate electrode.
